(19) United States
(12) Patent Application Publication
(10) Pub. No.: US 2025/0176018 A1
(43) Pub. Date: May 29, 2025

(54) METHOD, DEVICE AND COMPUTER READABLE MEDIUM FOR COMMUNICATIONS

(71) Applicant: Nokia Technologies Oy, Espoo (FI)

(72) Inventors: Renato Barbosa ABREU, Aalborg (DK); Timo Erkki LUNTTILA, Espoo (FI); Nuno Manuel KIILERICH PRATAS, Aalborg (DK); Yong LIU, Shanghai (CN); Naizheng ZHENG, Beijing (CN); Laura Luque SANCHEZ, Aalborg (DK); Ling YU, Espoo (FI)

(21) Appl. No.: 18/839,628

(22) PCT Filed: Apr. 20, 2022
(86) PCT No.: PCT/CN2022/088030

§ 371 Date: Aug. 19, 2024

(51) Int. Cl. H04W 74/0808; H04W 28/26; H04W 72/02; H04W 72/563; H04W 74/08

(52) U.S. Cl. CPC H04W 74/0808; H04W 28/26; H04W 72/02; H04W 72/563; H04W 74/0875

(57) ABSTRACT

Embodiments of the present disclosure relate to method, device and computer readable media for communications. A first device determines an expected time interval of a channel access procedure for transmission on a first candidate resource in an initial set of candidate resources. In accordance with a determination that the expected time interval overlaps with transmitting symbols of at least one reserved resource preceding the first candidate resource, the first device determines a first set of candidate resources for sidelink transmission by excluding the first candidate resource from the initial set.

### TECHNICAL FIELD

Implementations of the present disclosure generally relate to the field of telecommunication, and in particular, to a method, device and computer readable medium for communications.

### BACKGROUND

Certain communication systems enable vehicle to everything (V2X) and device to device (D2D) communications to be performed. V2X communications can be based on communication technologies such as sidelink communication technologies. For this, sidelink resource pools and sidelink channels can be established for vehicles participating in such communications.

In V2X communications, there are two modes of resource allocation. In a first mode (also referred to as NR V2X mode 1 or mode 1 hereinafter), one terminal device may perform V2X communications with the other terminal device by using resources allocated by a network device. In a second mode (also referred to as NR V2X mode 2 or mode 2 hereinafter), one terminal device may perform V2X communications with the other terminal device by using resources autonomously selected in a resource pool by the one terminal device.

### SUMMARY

In general, example implementations of the present disclosure provide a method, device and computer readable medium for communications.

In a first aspect, there is provided a first device. The first device comprises at least one processor and at least one memory including computer program codes. The at least one memory and the computer program codes are configured to, with the at least one processor, cause the first device to: determine an expected time interval of a channel access procedure for transmission on a first candidate resource in an initial set of candidate resources; and in accordance with a determination that the expected time interval overlaps with transmitting symbols of at least one reserved resource preceding the first candidate resource, determine a first set of candidate resources for sidelink transmission by excluding the first candidate resource from the initial set.

In a second aspect, there is provided a method implemented at a first device. The method comprises: determining, at the first device, an expected time interval of a channel access procedure for transmission on a first candidate resource in an initial set of candidate resources; and in accordance with a determination that the expected time interval overlaps with transmitting symbols of at least one reserved resource preceding the first candidate resource, determining a first set of candidate resources for sidelink transmission by excluding the first candidate resource from the initial set.

In a third aspect, there is provided an apparatus. The apparatus comprises: means for determining an expected time interval of a channel access procedure for transmission on a first candidate resource in an initial set of candidate resources; and in accordance with a determination that the expected time interval overlaps with transmitting symbols of at least one reserved resource preceding the first candidate resource, means for determining a first set of candidate resources for sidelink transmission by excluding the first candidate resource from the initial set.

In a fourth aspect, there is provided a non-transitory computer readable medium. The non-transitory computer readable medium comprises program instructions for causing an apparatus to perform the method according to the second aspect.

It is to be understood that the summary section is not intended to identify key or essential features of implementations of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some implementations of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of a CCA slot in accordance with some implementations of the present disclosure;

FIG. 3 illustrates an example of acquisition of the COT by an initiating device via LBT Type 1 in accordance with some implementations of the present disclosure;

FIG. 4 illustrates an example of a contention window countdown procedure in accordance with some implementations of the present disclosure;

FIG. 5 illustrates examples of allowed gaps for which LBT Type 2 variant to be applicable in accordance with some implementations of the present disclosure;

FIG. 6 illustrates an example when a responding device has to acquire a new COT in accordance with some implementations of the present disclosure;

FIG. 7 illustrates an example of NR SL resource allocation in mode 2 in accordance with some implementations of the present disclosure;

FIG. 8 illustrates a flowchart of a legacy SL resource allocation method;

FIG. 9 illustrates a flowchart of a legacy method for forming the resource candidate set;

FIG. 10 illustrates an example of an SL slot structure in accordance with some implementations of the present disclosure;

FIG. 11 illustrates an example how other SL UEs can disrupt the contention window countdown procedure in accordance with some implementations of the present disclosure;

FIG. 12 illustrates a flowchart of an example method in accordance with some implementations of the present disclosure;

FIG. 13 illustrates an example of SL resource selection in accordance with some implementations of the present disclosure;

FIG. 14 illustrates another example of SL resource selection in accordance with some implementations of the present disclosure;

FIG. 15 illustrates a flowchart of an example method in accordance with some implementations of the present disclosure;

FIG. 16 illustrates an example of RPs with different configurations to facilitate the transmission with LBT of different CWS;

FIG. 17 illustrates a simplified block diagram of an apparatus that is suitable for implementing embodiments of the present disclosure; and

FIG. 18 illustrates a block diagram of an example computer readable medium in accordance with some implementations of the present disclosure.

Throughout the drawings, the same or similar reference numerals represent the same or similar element.

### DETAILED DESCRIPTION

Principle of the present disclosure will now be described with reference to some example implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Implementations of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

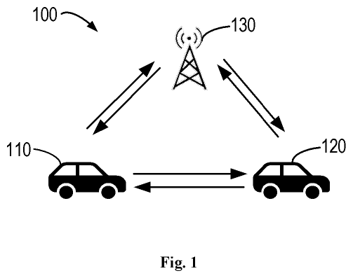

FIG. 1 illustrates a schematic diagram of an example communication network 100 in which implementations of the present disclosure can be implemented. As shown in FIG. 1, the communication network 100 may include a first device 110, a second device 120 and a third device 130. The third device 130 may communicate with the first device 110 and the second device 120 via respective wireless communication channels.

In this example, only for ease of discussion, the first device 110 and the second device 120 are illustrated as vehicles which enable V2X communications and the third device 130 is illustrated as a network device serving the devices 110 and 120. It is to be understood that the terminal device and the network device are only example implementations of the first device 110, the second device 120 and the third device 130, respectively, without suggesting any limitation as to the scope of the present application. Any other suitable implementations are possible as well.

It is to be understood that the number of devices in FIG. 1 is given for the purpose of illustration without suggesting any limitations to the present disclosure. The communication network 100 may include any suitable number of devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

### 1. Unlicensed Operation Background

In some implementations, the communications in the communication network 100 may comprise sidelink (SL) communication. In sub-7 GHz unlicensed bands, the new radio (NR) coexistence with other systems (e.g. IEEE 802.11) is ensured via a Listen Before Talking (LBT) channel access mechanism. According to the channel access mechanism, a user equipment (UE) intending to perform an SL transmission needs first to successfully complete an LBT check, before being able to initiate the same transmission. An LBT procedure may also be referred as Clear Channel Assessment (CCA) or channel access procedure.

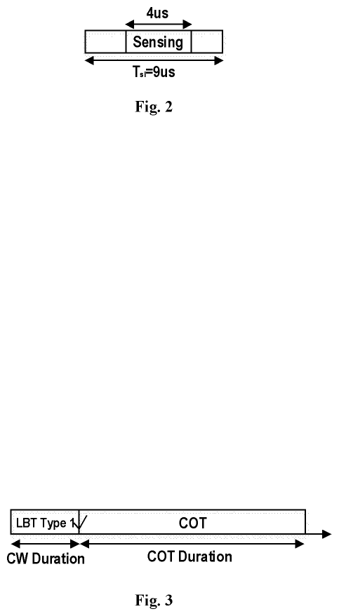

For a UE to pass an LBT check, it must observe the channel as available for a number of consecutive CCA slots. In sub-7 GHz, the duration of these slots is 9 μs, as depicted in FIG. 2. FIG. 2 shows that CCA slot has a duration Ts=9 μs, where the energy sensing takes place during 4 μs. The UE deems the channel as available in a CCA slot if the measured power (i.e. the collected energy during the CCA slot) is below a regulatory specified threshold which may depend on the operating band and geographical region.

When a UE initiates the communication (i.e. the UE takes the role of initiating device), this UE has to acquire the “right” to access the channel for a certain period of time—denoted in the regulations as the Channel Occupancy Time (COT)—by applying an “extended” LBT procedure where the channel must be deemed as free for the entire duration of a Contention Window (CW). This “extended” LBT procedure is commonly known as LBT Type 1 as specified in TS 37.213. This procedure is illustrated in FIG. 3.

Both of a CW duration and a COT duration in FIG. 3 depend on the Channel Access Priority Class (CAPC) associated with the UE's traffic, as shown in Table 1. Control plane traffic (such as PSCCH) is transmitted with p=1, while user plane traffic has p>1. Table 1 depicts the LBT Type 1 details for the Uu uplink (UL) case. It will be noted that the downlink (DL) case LBT Type 1 parameters could also in principle be adopted in SL.

TABLE 1

| Channel | | | | | |
|---|---|---|---|---|---|
| Access | | | | | |
| Priority | | | | | |
| Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | (15, 31, 63, 127, |
| | | | | 10 ms | 255, 511, 1023} |

NOTE1:
For p = 3,4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 us. The maximum duration before including any such gap shall be 6 ms.

Table 1 shows CAPC for UL. The contention window length in CCA slots associated with each CAPC has a minimum (CW_{min, p}) and maximum (CW_{max, p}). The duration of the COT is given by T_{ulm cot, p}.

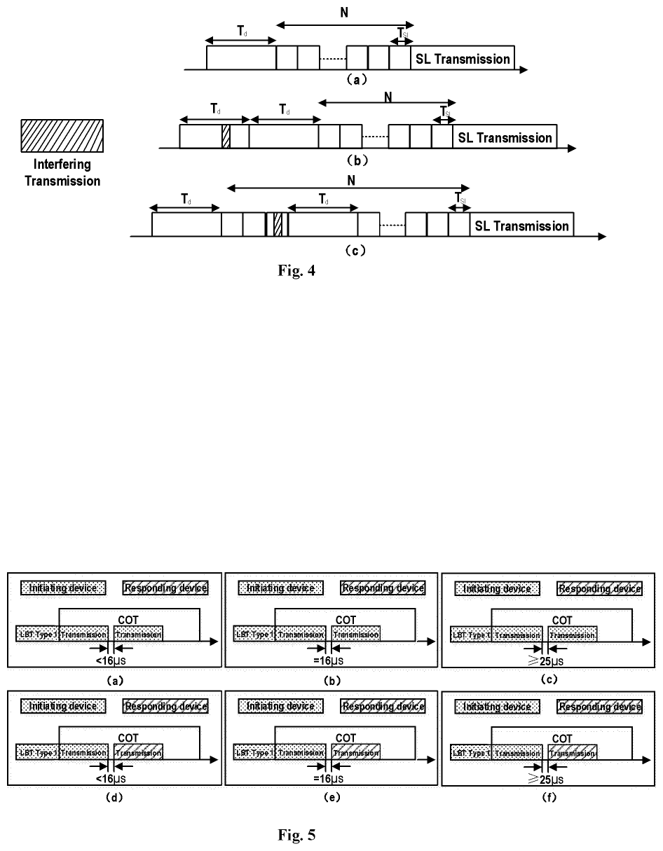

Examples of behavior during the contention window countdown procedure are depicted in FIG. 4. It should be noted that if during the countdown procedure the LBT check fails in any CCA slot, the countdown procedure will stop and will only resume if the channel is deemed as free (i.e. the LBT check is successful) during a defer time.

Specifically, FIG. 4 shows LBT Type 1 contention window countdown procedure and examples on how it can be disrupted, In an example (a), when neither the defer time nor the countdown are disrupted (i.e., the channel is not detected as busy during a sensing slot). In an example (b), the defer time is disrupted (i.e., the channel is detected as busy during a defer time sensing slot). In an example (c), the contention window countdown is disrupted (i.e., the channel is detected as busy during a sensing slot of the countdown). In FIG. 4, T_{d} represents the defer time, Tₛₗ represents the CCA slot duration and N represents the number of CCA slots required to be deemed as free before the contention window countdown is complete.

The UE initiating the transmission (also referred to as the initiating device) upon successfully completing the LBT Type 1 and performing a transmission, acquires the COT with duration associated with the corresponding CAPC. The acquired COT is valid even in the case where the initiating device pauses its transmission, although if the initiating device wants to perform a new transmission (within the COT) it is still required to perform a “reduced” LBT procedure. This “reduced” LBT procedure is commonly known as LBT Type 2 with the following variants:
Type 2A (25 μs LBT)—for SL transmissions within the initiating device acquired COT (in case the gap between two SL transmissions is ≥25 μs, as well for SL transmissions following another SL transmission), as depicted in examples (c) and (f) in FIG. 5;
Type 2B (16 μs LBT)—for SL transmission within the initiating device acquired COT (can only be used for SL transmissions following another SL with gap exactly equal to 16 μs), depicted in examples (b) and (e) in FIG. 5;
Type 2C (no LBT)—which can only be used for SL transmission following another SL, with a gap <16 μs and the allowed duration of the SL transmission≤584 μs, as depicted in examples (a) and (d) in FIG. 5.

In addition, the examples (a), (b) and (c) show the case where the gap is between the two transmissions both from the initiating UE, while the examples (d), (e), and (f) show the case that the gap is between the two different transmissions from the initiating UE and the responding UE correspondingly.

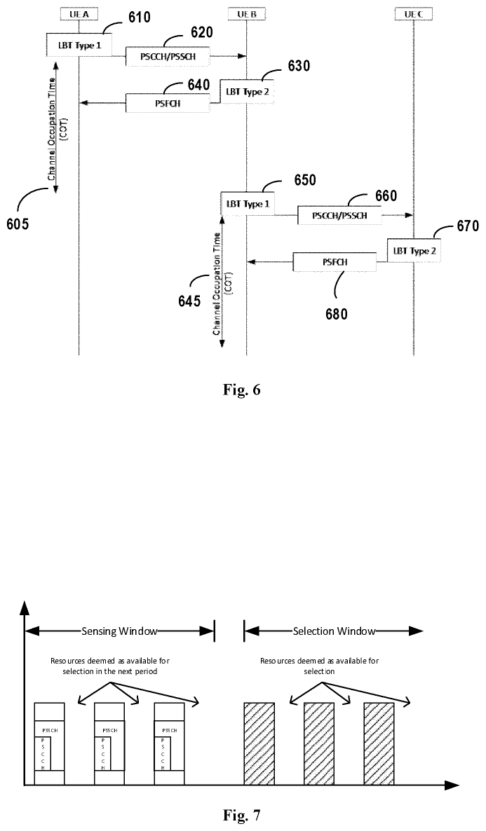

The initiating device may share its acquired COT with its intended receiver (also referred to as the responding device). For this purpose, the initiating device shall inform (e.g. via control signaling) the responding device about the duration of this COT. The responding device uses then this information to decide which type of LBT it should apply upon performing a transmission for which the intended receiver is the initiating device. In case the responding device transmission falls outside the COT, then the responding device will have to acquire a new COT using the LBT Type 1 with the appropriate CAPC. This will be described with reference to FIG. 6.

FIG. 6 illustrates an example when a responding device has to acquire a new COT. UE A acquires a new COT 605 using an LBT Type 1 procedure 610. UE A may transmit SL transmission 620 on PSCCH and/or PSSCH to UE B. In addition, UE A shares its acquired COT with UE B. UE B then uses this information to decide which type of LBT it should apply upon performing a transmission for which the intended receiver is UE A. For this purpose, UE A shall inform (e.g. via control signaling) UE B about the duration of the COT 605. In this example, upon receiving the SL transmission 620, UE B performs an LBT Type 2 procedure 630 and transmits SL feedback information 640 on PSFCH to UE A in response to a success of the LBT Type 2 procedure 630.

Because transmission from UE B to UE C falls outside the COT 605, UE B has to acquire a new COT 645 using an LBT Type 1 procedure 650 with the appropriate CAPC. UE B may transmit SL transmission 660 on PSCCH and/or PSSCH to UE C. In addition, UE B shares its acquired COT with UE C. UE C then uses this information to decide which type of LBT it should apply upon performing a transmission for which the intended receiver is UE B. For this purpose, UE B shall inform (e.g. via control signaling) UE C about the duration of the COT 645. In this example, upon receiving the SL transmission 660, UE C performs an LBT Type 2 procedure 670 and transmits SL feedback information 680 on PSFCH to UE B in response to a success of the LBT Type 2 procedure 670.

### 2. NR-SL Overview

NR SL has been designed to facilitate a user equipment (UE) to communicate with other nearby UE(s) via direct/SL communication. Two resource allocation modes have been specified, and a SL transmitter (TX) UE (such as the first device 110 or the second device 120) is configured with one of them to perform its NR SL transmissions. These modes are denoted as NR SL mode 1 and NR SL mode 2. In mode 1, a sidelink transmission resource is assigned or scheduled by a network device (such as the third device 130) to the SL TX UE, while a SL TX UE in mode 2 autonomously selects its SL transmission resources.

In mode 1, the network device is responsible for the SL resource allocation, and the configuration and operation are similar to the one over the Uu interface.

FIG. 7 illustrates an example of NR SL resource allocation in mode 2. In mode 2, SL UEs perform autonomously the resource selection with the aid of a sensing procedure. More specifically, a SL TX UE in NR SL mode 2 first performs a sensing procedure over the configured one or more SL transmission resource pools in order to obtain the knowledge of one or more reserved resources by at least one other nearby SL TX UE. Based on the knowledge obtained from sensing, the SL TX UE may select at least one resource from the available SL resources accordingly. In order for a SL UE to perform sensing and obtain the necessary information to receive a SL transmission, it needs to decode the sidelink control information (SCI). In Release 16, the SCI associated with a data transmission includes a 1st-stage SCI and 2nd-stage SCI.

### 2.1 NR SL Resource Allocation Mode 2

As mentioned above, in mode 2, each UE autonomously selects resources by decoding physical sidelink control channel (PSCCH) (or sidelink control information (SCI)) and performing RSRP measurement of at least one configured or pre-configured resource pool based on a procedure on a candidate resource pool during a sensing window interval.

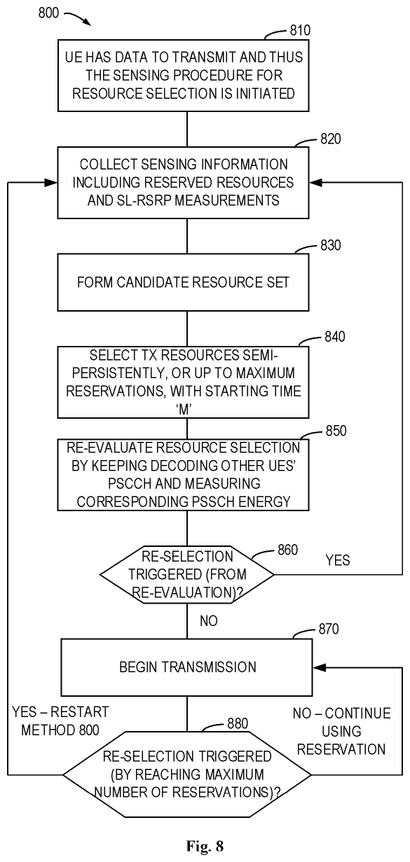

FIG. 8 illustrates a flowchart of a legacy SL resource allocation method 800. As shown in FIG. 8, at block 810, UE has data to transmit and thus the sensing procedure for resource selection is initiated.

At block 820, UE collects sensing information including reserved resources and SL-RSRP measurements.

At block 830, UE forms a candidate resource set.

At block 840, UE selects Tx resources semi-persistently, or up to maximum reservations, with starting time ‘m’.

At block 850, UE re-evaluates resource selection by keeping decoding other UEs' PSCCH and measuring corresponding PSSCH energy.

At block 860, UE determines whether resource re-selection is triggered (from re-evaluation).

If the resource re-selection is not triggered, UE begins transmission at block 870. If the resource re-selection is triggered, the method 800 proceeds to block 820.

At block 880, UE determines whether resource re-selection is triggered by reaching maximum number of reservations.

If the resource re-selection is triggered by reaching maximum number of reservations, UE restarts the method 800 and method 800 proceeds to block 820. If the resource re-selection is not gered by reaching maximum number of reservations, UE continues using reservation and the method 800 proceeds to block 870.

In the method 800, regarding the block 810, the monitoring of the resource pool and acquisition of information to be used during the resource selection procedure can be done prior to the Tx UE knowing that it has a transmission to perform. In addition, regarding the block 830, after the Tx UE has acquired enough information from its monitoring of the resource pool it can form the candidate resource set.

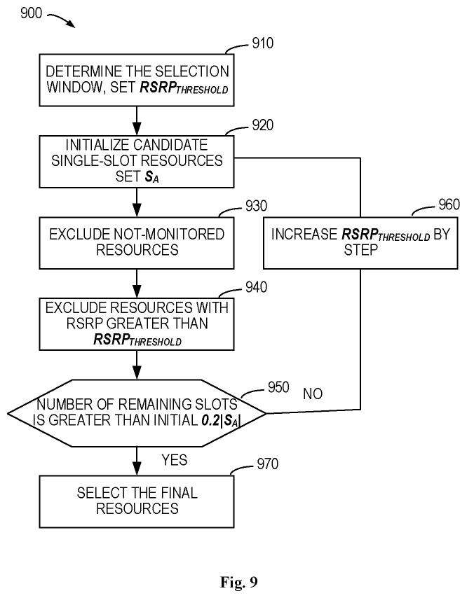

FIG. 9 illustrates a flowchart of a legacy method 900 for forming the resource candidate set. A method 900 occurs for resources within a candidate resource pool, which have been monitored during a sensing window interval. During this sensing window interval, UE collects the set of S_{A} of potential candidate resource slots that are within a defined selection window period and excludes all resources/slots which meet at least one of the following:
The UE has not monitored them during the sensing period (e.g. due to own transmission or other activities including DRX); and
The decoded SCI format 1-A indicates that the candidate slot is reserved and the corresponding measured RSRP is above a pre-configured RSRP_{threshold}.

Specifically, as shown in FIG. 9, at block 910, UE determines the selection window and set RSRP_{threshold}.

At block 920, UE initializes a candidate single-slot resource set S_{A}.

At block 930, UE excludes not-monitored resources from the set S_{A}.

At block 940, UE excludes resources with RSRP greater than RSRP_{threshold} from the set S_{A}.

At block 950, UE determines whether the number of remaining slots is greater than |X, S_{A}|, where X=0.2, 0.35, or 0.5, |S_{A}| represents the initial total number of resources in the set S_{A}.

If the number of remaining slots is less than |X,S_{A}|, UE increases, at block 960, the RSRP_{threshold} by a step (i.e., RSRP_{threshold}=RSRP_{threshold}+step, where the step is currently defined to be 3 dB). Then, the method 900 proceeds to block 920.

If the number of remaining slots is greater than |X, S_{A}|, UE, at block 970, forwards the potential candidate slots to the higher for final resource selection.

### 2.2 SL Physical Layer Structure

The configuration of the resources in the sidelink resource pool defines the minimum information required for a RX UE to be able to decode a transmission, which includes the number of sub-channels, the number of PRBs per sub-channels, the number of symbols in the PSCCH, which slots have a PSFCH and other configuration aspects not relevant to this invention.

However, the details of the actual sidelink transmission (i.e., the payload) are provided in the PSCCH (1st-stage SCI) for each individual transmission, which includes: the time and frequency resources, the DMRS configuration of the PSSCH, the MCS, PSFCH, among others.

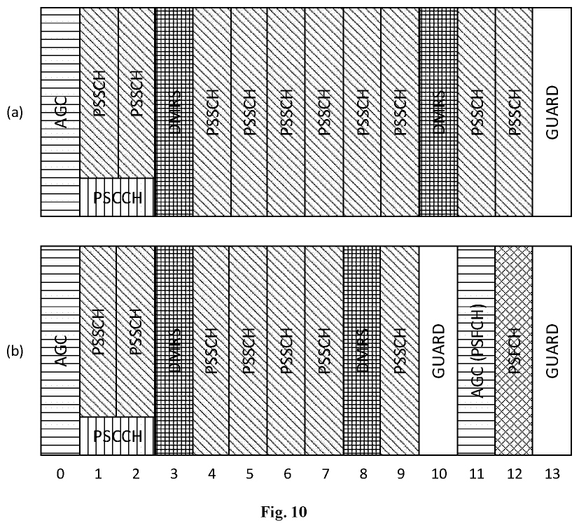

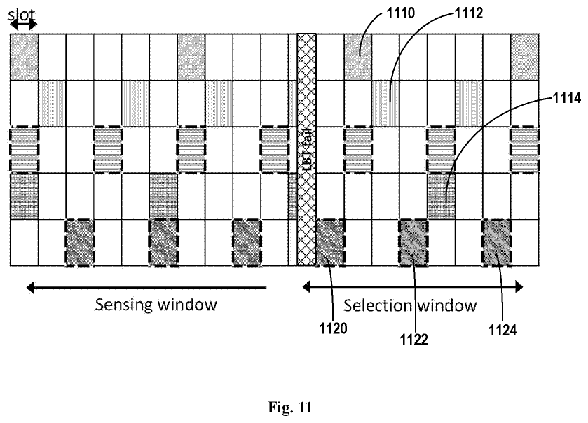

An example of the SL slot structure is depicted in FIG. 10, where it shows a slot with PSCCH/PSSCH in an example (a) and a slot with PSCCH/PSSCH where the last symbols are used for PSFCH in an example (b).

Table 2 shows PSSCH DMRS configurations based on the number of used symbols and duration of the PSCCH.

TABLE 2

| | DM-RS position l̅ | | | | | |
|---|---|---|---|---|---|---|
| | PSCCH duration 2 symbols | | | PSCCH duration 3 symbols | | |
| l_{d} in | Number of PSSCH DM-RS | | | Number of PSSCH DM-RS | | |
| symbols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

The configuration of the PSCCH (e.g., DMRS, MCS, number of symbols used) is part of the resource pool configuration. Furthermore, the indication of which slots have PSFCH symbols is also part of the resource pool configuration. However, the configuration of the PSSCH (e.g., the number of symbols used, the DMRS pattern and the MCS) is provided by the 1st-stage SCI which is the payload sent within the PSCCH and follows the configuration as depicted in Table 2.

As described in background, currently for SL communications operating with SL Mode 2, the UE determines the set of candidate single-slot resources by checking which single-slot resources are not reserved by other UEs based on received SCIs and whether the RSRP associated to each of these SCIs are below a threshold. Then from that candidate single-slot resource set, the UE can uniform randomly select the required resources.

However, this resource selection procedure does not take into account that the UE has to successfully complete the LBT procedure (either LBT Type 1 or Type 2) before it can perform a transmission in the selected resource(s). Furthermore, the successful completion of the LBT Type 1 procedure (namely the contention window countdown procedure) can be impacted by other SL UEs activity as well as other WiFi devices.

FIG. 11 illustrates an example how other SL UEs can disrupt the contention window countdown procedure associated with SL UE's LBT Type 1 procedure. Namely, upon sensing the resource pool and determining a resource to be free to be used and then selecting it for its transmission, a UE can be prevented from using the resource due to the contention window countdown not being successfully completed (due to disruption) within the starting time of the selected resource. The impact is higher for UE with high CAPC transmission, which is generally associated with a rather long contention window duration. This disruption of the contention window countdown can be either caused by a WiFi (or LTE LAA/NR-U) device performing a transmission as well as from a SL transmission taking place in the slot preceding the slot of the selected resource. However, while the disruption caused by a WiFi device is not known a priori, this is not the case for the other SL transmissions since the UE can become aware of these both during the sensing procedure as well by normal monitoring of the resource pool. Furthermore, if the LBT contention window overlaps with transmitting symbols of another UE's reserved resource, there is high likelihood of LBT failure occurring during the contention window countdown, which can prevent the SL UE from being able to succeed on the final LBT check right before the start of the selected resource. In other words, disregarding the impact of the LBT procedures into the mode 2 resource selection procedure will lead to very inefficient resource selection.

In FIG. 11, it is assumed that resources 1110, 1112 and 1114 are sensed to be reserved by another UE while resources 1120, 1122 and 1124 are available candidate resources. Even if the resources 1120, 1122 and 1124 are sensed as free candidate resources, the UE may have issues if the UE selects it. Depending on LBT contention window, the LBT procedure may likely fail since another UE has a reserved transmission right before the resources 1120, 1122 and 1124.

NR-U supports multiple transmission starting point by allocation of consecutive slots for transmission. In NR-U, the reserved contiguous allocations are for different transmission blocks (TBs) of a UE. But in SL, the resource reservations are for one or multiple retransmissions of a TB, or for different TBs in case of SPS allocation.

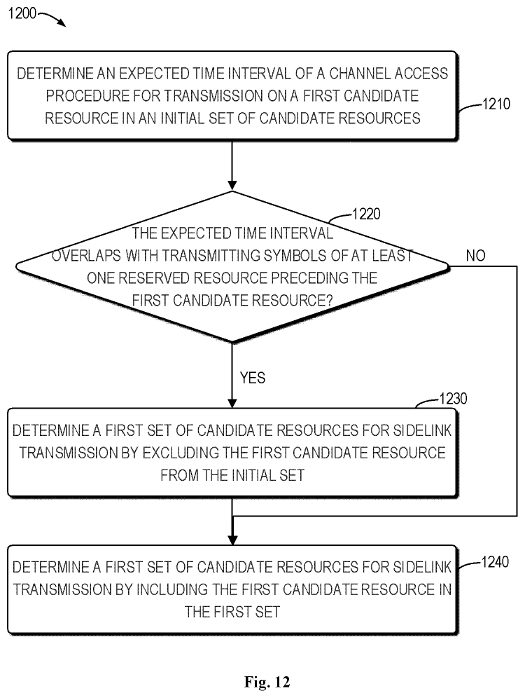

Implementations of the present disclosure provide a solution for SL resource selection so as to solve the above problems and one or more of other potential problems. According to the solution, whenever a device performs the sensing based resource selection and it knows that it will need to be able to complete a channel access procedure before performing its transmission, that it takes into account the associated channel access procedure duration (i.e., the contention window countdown) when selecting the resource. More specifically, according to the solution, a first terminal device determines an expected time interval of a channel access procedure for transmission on a first candidate resource in an initial set of candidate resources. If the expected time interval overlaps with transmitting symbols of at least one reserved resource preceding the first candidate resource, the first terminal device excludes the first candidate resource from the initial set. Hereinafter, principle of the present disclosure will be described with reference to FIGS. 12 to 17.

FIG. 12 illustrates a flowchart of an example method 1200 in accordance with some implementations of the present disclosure. In some implementations, the method 1200 can be implemented at a device, such as the device 110 or the device 120 as shown in FIG. 1. For the purpose of discussion, the method 1200 will be described with reference to FIG. 1 as performed by the first device 110 without loss of generality.

At block 1210, the first device 110 determines an expected time interval of a channel access procedure for transmission on a first candidate resource in an initial set of candidate resources.

At block 1220, the first device 110 determines whether the expected time interval overlaps with transmitting symbols of at least one reserved resource preceding the first candidate resource.

If the expected time interval overlaps with transmitting symbols of at least one reserved resource preceding the first candidate resource, the first device 110 determines, at block 1230, a first set of candidate resources for sidelink transmission by excluding the first candidate resource from the initial set.

In some implementations, the at least one reserved resource may comprise a preconfigured number of reserved resources preceding the first candidate resource.

In some implementations, optionally, if the expected time interval does not overlap with the transmitting symbols of at least one reserved resource preceding the first candidate resource, the first device 110 may determines, at block 1240, the first set of candidate resources by including the first candidate resource in the first set.

The method 1200 enables the exclusion of all resources which will anyway not be usable due to the LBT Type 1 procedure not being successfully completed at the time instant where the resource associated slot starts, thus avoiding inefficient selection of unusable resources.

In some implementations, the method 1200 may be executed for each candidate resource in the initial set.

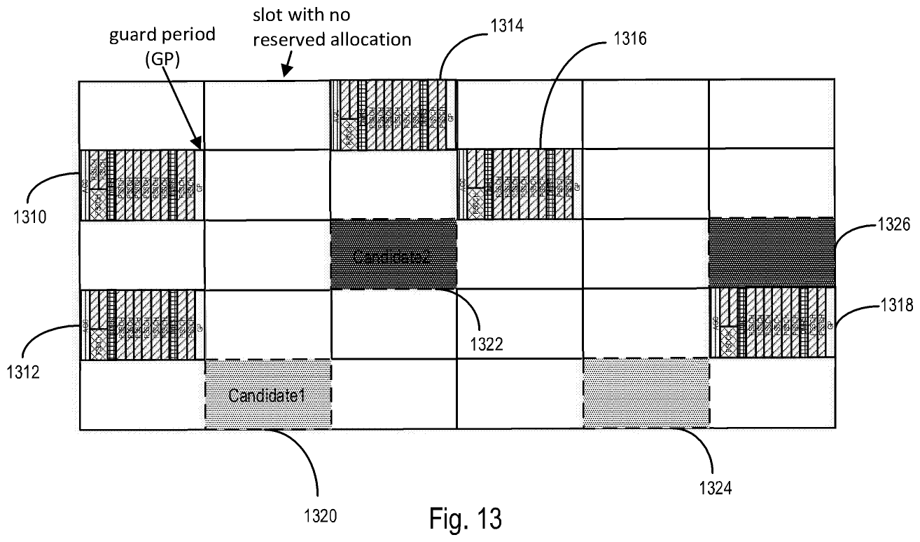

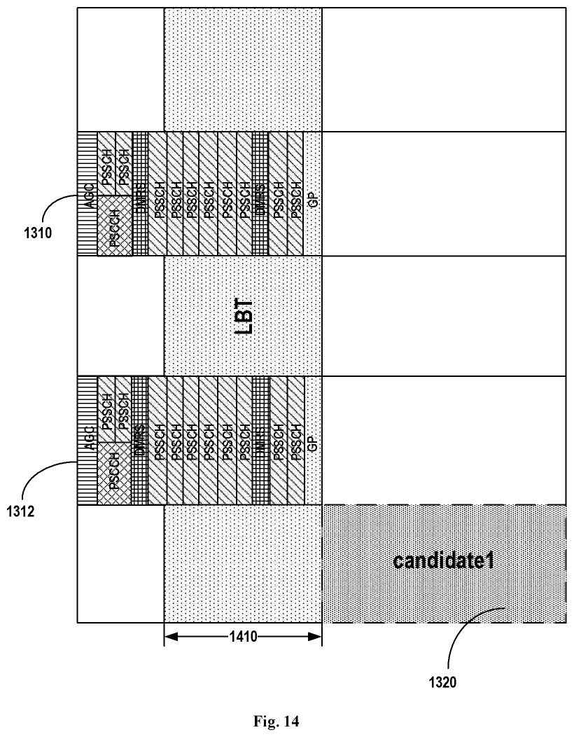

FIG. 13 illustrates an example of SL resource selection in accordance with some implementations of the present disclosure. In this example, resources 1310, 1312, 1314, 1316 and 1318 are reserved resource by the second device 120. An initial set of candidate resources includes resources 1320, 1322, 1324 and 1326 which are sensed as free candidate resources.

In each of the reserved resources 1310, 1312, 1314, 1316 and 1318, the second device 120 may occupy symbols except the last guard period (GP) symbol to perform SL transmission. Thus, the occupied symbols except the last guard period (GP) symbol in each of the reserved resources 1310, 1312, 1314, 1316 and 1318 are also referred to as transmitting symbols.

The first device 110 determines whether an expected time interval of a channel access procedure for transmission on the candidate resource 1320 overlaps with the transmitting symbols of the reserved resources 1310 and 1312 preceding the candidate resource 1320. If the expected time interval overlaps with the transmitting symbols of the reserved resources 1310 and 1312 preceding the candidate resource 1320, the first device 110 may exclude the candidate resource 1320 from the initial set of candidate resources. In this case, the first device 110 may include the candidate resource 1322 after the candidate resource 1320 in the initial set of candidate resources.

Similarly, the first device 110 determines whether an expected time interval of a channel access procedure for transmission on the candidate resource 1324 overlaps with the transmitting symbols of the reserved resource 1316 preceding the candidate resource 1324. If the expected time interval overlaps with the transmitting symbols of the reserved resource 1316 preceding the candidate resource 1324, the first device 110 may exclude the candidate resource 1324 from the initial set of candidate resources. In this case, the first device 110 may include the candidate resource 1326 after the candidate resource 1324 in the initial set of candidate resources.

In some implementations, for transmissions with a high CAPC (i.e., lower priority traffic), it is expected that the contention window countdown procedure will require several symbols (and in some extreme cases several slots). Therefore, at least a full empty slot might be needed preceding the slot of the resource being evaluated in order for this resource to not be excluded.

In some implementations, transmissions in a slot following empty slots may be restricted to initial transmissions so that a Type 1 channel access procedure can be performed within the unallocated slot time. In other words, the Type 1 channel access procedure requires one or more unoccupied slots before it can be finalized. In this case, the exclusion of resource may be dependent on whether the RSRP associated with the SCI, where the previous slot reserved transmission was indicated, is above a configured RSRP threshold.

In some implementations, if the channel access procedure is a type 1 channel access procedure and a CAPC for the transmission is higher than a pre-defined value, the first device 110 may exclude the first candidate resource if there is a reserved resource preceding the first candidate resource.

In some implementations, if the channel access procedure is a type 2 channel access procedure and the time interval is shorter than a guard period of the at least one reserved resource, the first device 110 may include the first candidate resource in the first set if there is a reserved resource preceding the first candidate resource.

In some implementations, a type 1 channel access procedure with lower CAPC (high priority) has higher likelihood of successfully complete within a guard symbol or period time because less time/duration of the channel access procedure is needed. For example, CAPC-1 has a CW of up to 7 CCA slots (i.e., 63 us) which is smaller than the guard symbol length (about 71 us) in 15 kHz sub-carrier spacing. Similarly, for transmissions within a shared COT which can use a type 2 channel access procedure (that takes up to 25 us), a channel access procedure may be successfully completed within a guard symbol. On the other hand, a type 1 channel access procedure with higher CAPC (for low priority transmission or targeting large COT size) may not complete within a guard symbol since CW of CAPC-3 starts from 15 CCA slots (135 us).

In some implementations, the first device 110 acquiring the COT may also share the COT with other neighbor devices if they have reserved allocation following the slot allocated by the first device 110. COT sharing information may be transmitted through SCI or like configured grant uplink control information (CG-UCI) from NR-U.

In some implementations, for transmission with a low CAPC (i.e., high priority traffic), or a transmission within a COT, it is expected that the contention window countdown procedure may be contained within the guard period of the previous transmission and therefore in this case a resource is not excluded. In other words, the Type 1 channel access procedure may be finalized within the duration of the guard period (i.e., unoccupied symbols) of the allocation prior to the reserved resource.

In some implementations, the exclusion of the resource may be also dependent on whether the expected time interval of the channel access procedure and an additional time buffer (to account any potential disruption due to WiFi devices activity) overlaps in time with a reserved transmission in a previous slot.

In some implementations, if the first device 110 succeeds in the channel access procedure and acquires the COT, it may be able to transmit in subsequent slots within the COT, subject to a type 2 channel access procedure. This means that, for example in FIG. 13, if the candidate resource 1320 is reserved, then the candidate resource 1322 can also be reserved if needed by the first device 110 since if the channel access procedure succeeds for transmission in the resource 1320, the COT can be used for transmission in the subsequent resources.

In some implementations, an energy threshold E_{threshold} may be used to estimate whether the energy level of other UEs transmission(s) will cause LBT failure in slots prior to the candidate resource. In such implementations, the first device 110 may estimate an energy level of a sidelink transmission on the transmitting symbols. If the estimated energy level is higher than an energy threshold and the expected time interval overlaps with the transmitting symbols, the first device 110 may exclude the first candidate resource.

In some implementations, if the energy threshold is in a predetermined range, the first device 110 may determine whether the estimated energy level is higher than the energy threshold.

In some implementations, the first device 110 may be configured with the value of E_{threshold}. In some implementations, the configuration may be used to disable some implementations of the present disclosure. For example, a high or inapplicable value of E_{threshold} would mean that the first device 110 may not take into account potential LBT failures caused by transmissions on preceding reserved resource.

The energy measurement may be based on RSSI, or other energy related measurement such as RSRP, Carrier-to-Interference Ratio (CIR), Signal Noise Ratio (SNR) and so on, of the other UEs' transmissions measured during the sensing window. Based on that, if the combined energy estimate of transmissions prior to the candidate resource are below the energy threshold E_{threshold}, the candidate resource is not excluded from selection. This will be described with reference to FIG. 14.

FIG. 14 illustrates another example of SL resource selection in accordance with some implementations of the present disclosure. In this example, the first device 110 estimates an energy level of a sidelink transmission on the transmitting symbols of the reserved resources 1310 and 1312. If the estimated energy level is higher than an energy threshold and the expected time interval 1410 of the LBT procedure for transmission on the candidate resource 1320 overlaps with the transmitting symbols, the first device 110 excludes the candidate resource 1320 from the initial set. On the other hand, if the estimated energy level is lower than the energy threshold and the expected time interval 1410 overlaps with the transmitting symbols, the first device 110 may not exclude the candidate resource 1320 from the initial set.

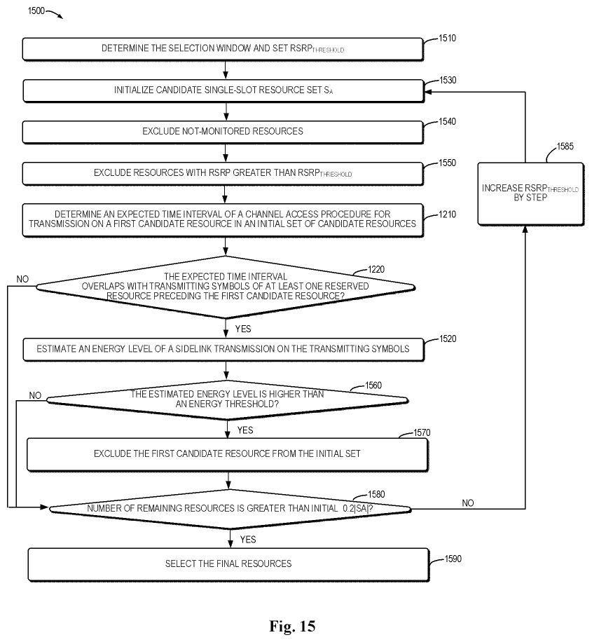

FIG. 15 illustrates a flowchart of an example method 1500 in accordance with some implementations of the present disclosure. The method 1500 may be considered as an example implementation of the method 1200. In some implementations, the method 1500 can be implemented at a device, such as the device 110 or the device 120 as shown in FIG. 1. For the purpose of discussion, the method 1500 will be described with reference to FIG. 1 as performed by the first device 110 without loss of generality.

At block 1510, the first device 110 determines the selection window and set RSRP_{threshold}.

At block 1530, the first device 110 initializes a candidate single-slot resource set S_{A}. Hereinafter, the set S_{A} is also referred to as an initial set of candidate resources.

At block 1540, the first device 110 excludes not-monitored resources from the initial set.

At block 1550, the first device 110 excludes resources with RSRP greater than RSRP_{threshold} from the initial set.

At block 1210, the first device 110 determines an expected time interval of a channel access procedure for transmission on the first candidate resource. The block 1210 in FIG. 15 is the same the block 1210 in FIG. 12 and thus the details of the block 1210 are omitted.

In turn, the first device 110 determines, at block 1220, whether the expected time interval overlaps with transmitting symbols of at least one reserved resource preceding the first candidate resource. The block 1220 in FIG. 15 is the same the block 1210 in FIG. 12 and thus the details of the block 1220 are omitted.

If the expected time interval overlaps with the transmitting symbols of at least one reserved resource preceding the first candidate resource, the first device 110 estimates, at block 1520, an energy level of a sidelink transmission on the transmitting symbols of at least one reserved resource preceding the first candidate resource in an initial set of candidate resources.

At block 1560, the first device 110 determines whether the estimated energy level is higher than an energy threshold.

If the estimated energy level is higher than the energy threshold, the first device 110 excludes, at block 1570, the first candidate resource from the initial set.

At block 1580, the first device 110 determines whether the number of remaining resources is greater than 20% of the initial total number of resources in the initial set.

If the number of remaining resources is less than 20% of the initial total number of resources in the initial set, the first device 110 increases the RSRP_{threshold} by a step, such as 3 dB. Then, the method 1500 proceeds to block 1530.

If the number of remaining resources is greater than 20% of the initial total number of resources in the initial set, the first device 110 selects the final resources at block 1590.

On the other hand, if the first device 110 determines, at block 1220, the expected time interval does not overlap with transmitting symbols of at least one reserved resource preceding the first candidate resource, or the first device 110 determines, at block 1560, the estimated energy level is less than the energy threshold, the method 1500 may proceed to block 1580.

In some implementations, if there is no resources available in the first set of candidate resources for which the time interval of the channel access procedure does not overlap with transmitting symbols of a reserved resource, the first device 110 may perform at least one of the following: determining the first set of candidate resources which includes the first candidate resource, extending a sensing window, or increasing a measurement threshold for finding candidate resources for which time intervals of channel access procedures do not overlap with transmitting symbols of reserved resources in the initial set.

In other words, if after determining candidates resources, there is no resource available after an unoccupied slot which fits the remaining duration of the channel access procedure (or a channel access procedure with greater contention window size (CWS)), the first device 110 may decide to select the candidate resource anyway (which was to be excluded) with the risk of failure of the channel access procedure caused by other SL transmission. Alternatively, the first device 110 may extend its sensing window and/or increase the SCI RSRP threshold to increase chance of finding more available resource options that give sufficient time for finalizing the channel access procedure.

In some implementations, the first device 110 may receive a configuration about at least one empty resource in a sidelink resource pool and exclude the at least one empty resource from the initial set of candidate resources.

In other words, in some implementations, certain subset of slots (e.g., following a periodic configuration) may be excluded from being used for Mode 2 resource selection, That is, some slots are configured to be empty, for example, using the parameter sl-TimeResource in 3GPP TS 38.331 in order to facilitate LBT of greater CWS. This configuration should be common for all SL devices. The empty slot may be excluded from any SL resource pool (RP), not only the RP that the first device 110 will use to reselect the resources. The proposed implementations for reserving resources after empty slots may be limited to apply to these configured slots only, or alternatively may be applicable to any slots that have been sensed to be empty.

In some implementations, the first device 110 may receive a first configuration about a first sidelink resource pool (RP) with a first start symbol and a first length of symbols. The first device 110 may also receive a second configuration about a second sidelink RP with a second start symbol and a second length of symbols. The second start symbol and the second length are different from the first start symbol and the first length, respectively. In turn, the first device 110 may select, based on a priority of the sidelink transmission, the initial set of candidate resources from one of the first and second sidelink RPs.

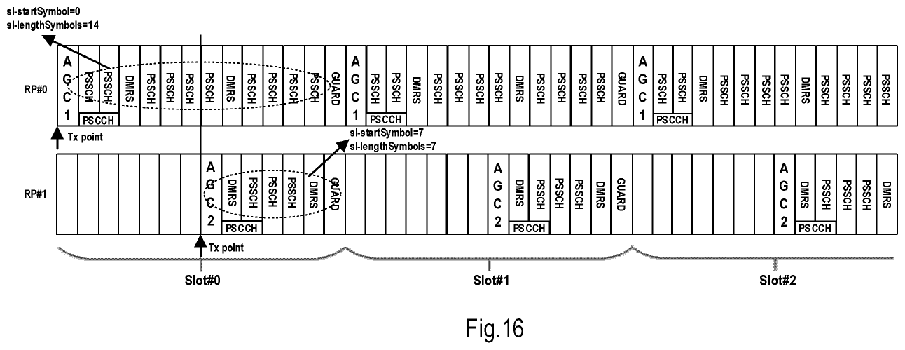

In other words, a semi-static approach can be taken for different RPs with different configurations of start symbol (represented by sl-startSymbol) and length of symbols (represented by sl-lengthSymbols) defined in the SL, to facilitate the transmission with LBT of different CWS. The semi-static approach may be taken especially for an SL device with high CAPC transmission which generally requires with a rather long contention window duration. RPs with different start and lengths can be in different LBT bandwidth. This will be described with reference to FIG. 16.

FIG. 16 illustrates an example of RPs with different configurations to facilitate the transmission with LBT of different CWS. As shown in FIG. 16, for a given SL BWP, one RP with configuration of sl-startSymbol=0 & sl-lengthSymbols=14, and the other RP with configuration of sl-startSymbol=7 & sl-lengthSymbols=7. Selection of Tx RP is based on CAPC associated with the intended transmission, i.e., one of the RPs may intend to high CAPC transmission, and the other for low CAPC. Thus, the first device 110 may exclude a candidate resource from RP which does not match the corresponding CAPC.

For instance, as shown in FIG. 16, for a lower CAPC transmission, the first device 110 may choose RP #0 if LBT can be guaranteed to be finalized within GUARD-symbol. For a higher CAPC transmission, the first device 110 may use RP #1, where the “white” symbols after the GUARD-symbol can be helpful to finalize the long LBT that required by high CAPC transmission and to avoid the LBT overlapping with other SL-U terminal device transmissions. The two RPs (e.g. RP #0 and RP #1) are configured in different unlicenced channels so that the transmission in RP #0 does not impact the LBT for the transmission in RP #1.

In some example implementations, an apparatus capable of performing any of the method 1200 (for example, an apparatus) may comprise means for performing the respective steps of the method 1200. The means may be implemented in any suitable form. For example, the means may be implemented in a circuitry or software module.

In some example implementations, the apparatus comprises: means for determining an expected time interval of a channel access procedure for transmission on a first candidate resource in an initial set of candidate resources; and in accordance with a determination that the expected time interval overlaps with transmitting symbols of at least one reserved resource preceding the first candidate resource, means for determining a first set of candidate resources for sidelink transmission by excluding the first candidate resource from the initial set.

In some implementations, the apparatus further comprises: means for estimating an energy level of a sidelink transmission on the transmitting symbols; and wherein means for excluding the first candidate resource comprises: in accordance with a determination that the estimated energy level is higher than an energy threshold and the expected time interval overlaps with the transmitting symbols, means for excluding the first candidate resource.

In some implementations, the apparatus further comprises: in accordance with a determination that the energy threshold is in a predetermined range, means for determining whether the estimated energy level is higher than the energy threshold.

In some implementations, the apparatus further comprises: in accordance with a determination that there is no resources available in the first set of candidate resources for which the time interval of the channel access procedure does not overlap with transmitting symbols of a reserved resource, means for performing at least one of the following: determining the first set of candidate resources which includes the first candidate resource,
extending a sensing window, or increasing a measurement threshold for finding candidate resources for which time intervals of channel access procedures do not overlap with transmitting symbols of reserved resources in the initial set.

In some implementations, the apparatus further comprises: means for receiving a configuration about at least one empty resource in a sidelink resource pool; and means for excluding the at least one empty resource from the initial set of candidate resources.

In some implementations, means for excluding the first candidate resource comprises: if the channel access procedure is a type 1 channel access procedure and a Channel Access Priority Class (CAPC) for the transmission is higher than a pre-defined value, means for excluding the first candidate resource if there is a reserved resource preceding the first candidate resource; and if the channel access procedure is a type 2 channel access procedure and the time interval is shorter than a guard period of the at least one reserved resource, means for including the first candidate resource in the first set if there is a reserved resource preceding the first candidate resource.

In some implementations, the apparatus further comprises: means for receiving a first configuration about a first sidelink resource pool with a first start symbol and a first length of symbols; means for receiving a second configuration about a second sidelink resource pool with a second start symbol and a second length of symbols, the second start symbol and the second length being different from the first start symbol and the first length, respectively; and means for selecting, based on a priority of the sidelink transmission, the initial set of candidate resources from one of the first and second sidelink resource pools.

In some implementations, the apparatus further comprises: means for excluding the first candidate resource from the initial set if a slot preceding the first candidate resource is empty and the channel access procedure is not a type 1 channel access procedure.

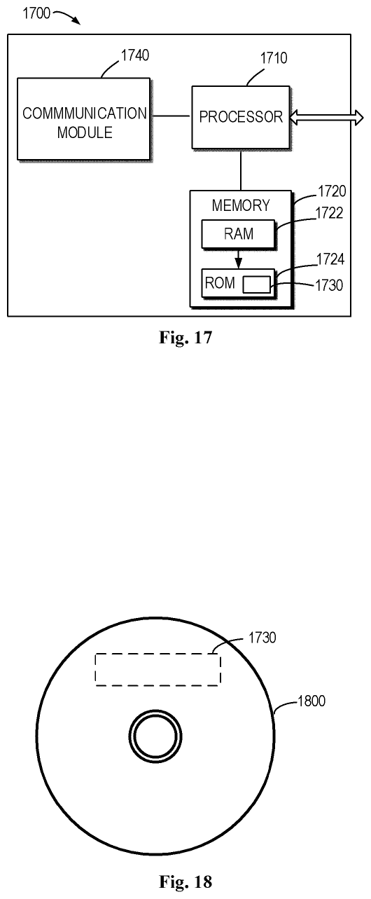

FIG. 17 is a simplified block diagram of a device 1700 that is suitable for implementing embodiments of the present disclosure. The device 1700 may be provided to implement the communication device, for example, the first device 110 or the second device 120 as shown in FIG. 1. As shown, the device 1700 includes one or more processors 1710, one or more memories 1720 coupled to the processor 1710, and one or more communication modules 1740 coupled to the processor 1710.

The communication module 1740 is for bidirectional communications. The communication module 1740 has at least one antenna to facilitate communication. The communication interface may represent any interface that is necessary for communication with other network elements.

The processor 1710 may be of any type suitable to the local technical network and may include one or more of the following: general purpose computers, special purpose computers, microprocessors, digital signal processors (DSPs) and processors based on multicore processor architecture, as non-limiting examples. The device 1700 may have multiple processors, such as an application specific integrated circuit chip that is slaved in time to a clock which synchronizes the main processor.

The memory 1720 may include one or more non-volatile memories and one or more volatile memories. Examples of the non-volatile memories include, but are not limited to, a Read Only Memory (ROM) 1724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1722 and other volatile memories that will not last in the power-down duration.

A computer program 1730 includes computer executable instructions that are executed by the associated processor 1710. The program 1730 may be stored in the ROM 1724. The processor 1710 may perform any suitable actions and processing by loading the program 1730 into the RAM 1722.

The embodiments of the present disclosure may be implemented by means of the program 1730 so that the device 1700 may perform any process of the disclosure as discussed with reference to FIGS. 1 to 16. The embodiments of the present disclosure may also be implemented by hardware or by a combination of software and hardware.

In some example embodiments, the program 1730 may be tangibly contained in a computer readable medium which may be included in the device 1700 (such as in the memory 1720) or other storage devices that are accessible by the device 1700. The device 1700 may load the program 1730 from the computer readable medium to the RAM 1722 for execution. The computer readable medium may include any types of tangible non-volatile storage, such as ROM, EPROM, a flash memory, a hard disk, CD, DVD, and the like. FIG. 18 shows an example of the computer readable medium 1800 in form of CD or DVD. The computer readable medium has the program 1730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 1200 and 1500 as described above with reference to FIGS. 12 and 15. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-25. (canceled)

26. A first device, comprising:
at least one processor; and
at least one memory including computer program code;
wherein the at least one memory and the computer program code are configured to, with the at least one processor, cause the first device to:
determine an expected time interval of a channel access procedure for transmission on a first candidate resource in an initial set of candidate resources; and
in accordance with a determination that the expected time interval overlaps with transmitting symbols of at least one reserved resource preceding the first candidate resource, determine a first set of candidate resources for sidelink transmission by excluding the first candidate resource from the initial set.

27. The first device of claim 26, wherein:
the first device is further caused to:
estimate an energy level of a sidelink transmission on the transmitting symbols; and
the first device is caused to exclude the first candidate resource by:
in accordance with a determination that the estimated energy level is higher than an energy threshold and the expected time interval overlaps with the transmitting symbols, excluding the first candidate resource.

28. The first device of claim 27, wherein the first device is further caused to:
in accordance with a determination that the energy threshold is in a predetermined range, determine whether the estimated energy level is higher than the energy threshold.

29. The first device of claim 26, wherein the first device is further caused to:
in accordance with a determination that there is no resources available in the first set of candidate resources for which the time interval of the channel access procedure does not overlap with transmitting symbols of a reserved resource, perform at least one of the following:
determining the first set of candidate resources which includes the first candidate resource,
extending a sensing window, or
increasing a measurement threshold for finding candidate resources for which time intervals of channel access procedures do not overlap with transmitting symbols of reserved resources in the initial set.

30. The first device of claim 26, wherein the first device is further caused to:
receive a configuration about at least one empty resource in a sidelink resource pool; and
exclude the at least one empty resource from the initial set of candidate resources.

31. The first device of claim 26, wherein the first device is caused to exclude the first candidate resource by:
if the channel access procedure is a type 1 channel access procedure and a Channel Access Priority Class (CAPC) for the transmission is higher than a pre-defined value, excluding the first candidate resource if there is a reserved resource preceding the first candidate resource; and
if the channel access procedure is a type 2 channel access procedure and the time interval is shorter than a guard period of the at least one reserved resource, including the first candidate resource in the first set if there is a reserved resource preceding the first candidate resource.

32. The first device of claim 26, wherein the first device is further caused to:
receive a first configuration about a first sidelink resource pool with a first start symbol and a first length of symbols;
receive a second configuration about a second sidelink resource pool with a second start symbol and a second length of symbols, the second start symbol and the second length being different from the first start symbol and the first length, respectively; and
select, based on a priority of the sidelink transmission, the initial set of candidate resources from one of the first and second sidelink resource pools.

33. The first device of claim 26, wherein the first device is further caused to:
if a slot preceding the first candidate resource is empty and the channel access procedure is not a type 1 channel access procedure, exclude the first candidate resource from the initial set.

34. A method, comprising:
determining, at a first device, an expected time interval of a channel access procedure for transmission on a first candidate resource in an initial set of candidate resources; and
in accordance with a determination that the expected time interval overlaps with transmitting symbols of at least one reserved resource preceding the first candidate resource, determining a first set of candidate resources for sidelink transmission by excluding the first candidate resource from the initial set.

35. The method of claim 34, further comprising:
estimating an energy level of a sidelink transmission on the transmitting symbols; and
wherein excluding the first candidate resource comprises:
in accordance with a determination that the estimated energy level is higher than an energy threshold and the expected time interval overlaps with the transmitting symbols, excluding the first candidate resource.

36. The method of claim 35, further comprising:
in accordance with a determination that the energy threshold is in a predetermined range, determining whether the estimated energy level is higher than the energy threshold.

37. The method of claim 34, further comprising:
in accordance with a determination that there is no resources available in the first set of candidate resources for which the time interval of the channel access procedure does not overlap with transmitting symbols of a reserved resource, performing at least one of the following:
determining the first set of candidate resources which includes the first candidate resource,
extending a sensing window, or
increasing a measurement threshold for finding candidate resources for which time intervals of channel access procedures do not overlap with transmitting symbols of reserved resources in the initial set.

38. The method of claim 34, further comprising:
receiving a configuration about at least one empty resource in a sidelink resource pool; and
excluding the at least one empty resource from the initial set of candidate resources.

39. The method of claim 34, wherein excluding the first candidate resource comprises:
if the channel access procedure is a type 1 channel access procedure and a Channel Access Priority Class (CAPC) for the transmission is higher than a pre-defined value, excluding the first candidate resource if there is a reserved resource preceding the first candidate resource; and
if the channel access procedure is a type 2 channel access procedure and the time interval is shorter than a guard period of the at least one reserved resource, including the first candidate resource in the first set if there is a reserved resource preceding the first candidate resource.

40. The method of claim 34, further comprising:
receiving a first configuration about a first sidelink resource pool with a first start symbol and a first length of symbols;
receiving a second configuration about a second sidelink resource pool with a second start symbol and a second length of symbols, the second start symbol and the second length being different from the first start symbol and the first length, respectively; and
selecting, based on a priority of the sidelink transmission, the initial set of candidate resources from one of the first and second sidelink resource pools.

41. The method of claim 34, further comprising:
if a slot preceding the first candidate resource is empty and the channel access procedure is not a type 1 channel access procedure, excluding the first candidate resource from the initial set.

42. A non-transitory computer readable medium comprising program instructions that, when executed by an apparatus, cause the apparatus to perform:
determining, at a first device, an expected time interval of a channel access procedure for transmission on a first candidate resource in an initial set of candidate resources; and
in accordance with a determination that the expected time interval overlaps with transmitting symbols of at least one reserved resource preceding the first candidate resource, determining a first set of candidate resources for sidelink transmission by excluding the first candidate resource from the initial set.

43. The computer readable medium of claim 42, further comprising program instructions that, when executed by the apparatus, cause the apparatus to perform:
estimating an energy level of a sidelink transmission on the transmitting symbols; and
wherein excluding the first candidate resource comprises:
in accordance with a determination that the estimated energy level is higher than an energy threshold and the expected time interval overlaps with the transmitting symbols, excluding the first candidate resource.

44. The computer readable medium of claim 43, further comprising program instructions that, when executed by the apparatus, cause the apparatus to perform:
in accordance with a determination that the energy threshold is in a predetermined range, determining whether the estimated energy level is higher than the energy threshold.

45. The computer readable medium of claim 42, further comprising program instructions that, when executed by the apparatus, cause the apparatus to perform:
in accordance with a determination that there is no resources available in the first set of candidate resources for which the time interval of the channel access procedure does not overlap with transmitting symbols of a reserved resource, performing at least one of the following:
determining the first set of candidate resources which includes the first candidate resource,
extending a sensing window, or
increasing a measurement threshold for finding candidate resources for which time intervals of channel access procedures do not overlap with transmitting symbols of reserved resources in the initial set.

46. The computer readable medium of claim 42, further comprising program instructions that, when executed by the apparatus, cause the apparatus to perform:
receiving a configuration about at least one empty resource in a sidelink resource pool; and
excluding the at least one empty resource from the initial set of candidate resources.

47. The computer readable medium of claim 42, wherein excluding the first candidate resource comprises:
if the channel access procedure is a type 1 channel access procedure and a Channel Access Priority Class (CAPC) for the transmission is higher than a pre-defined value, excluding the first candidate resource if there is a reserved resource preceding the first candidate resource; and
if the channel access procedure is a type 2 channel access procedure and the time interval is shorter than a guard period of the at least one reserved resource, including the first candidate resource in the first set if there is a reserved resource preceding the first candidate resource.

48. The computer readable medium of claim 42, further comprising program instructions that, when executed by the apparatus, cause the apparatus to perform:
receiving a first configuration about a first sidelink resource pool with a first start symbol and a first length of symbols;
receiving a second configuration about a second sidelink resource pool with a second start symbol and a second length of symbols, the second start symbol and the second length being different from the first start symbol and the first length, respectively; and
selecting, based on a priority of the sidelink transmission, the initial set of candidate resources from one of the first and second sidelink resource pools.

49. The computer readable medium of claim 42, further comprising program instructions that, when executed by the apparatus, cause the apparatus to perform:
if a slot preceding the first candidate resource is empty and the channel access procedure is not a type 1 channel access procedure, excluding the first candidate resource from the initial set.
